(19) United States
(12) Patent Application Publication
(10) Pub. No.: US 2015/0075265 A1
(43) Pub. Date: Mar. 19, 2015

(54) MEASUREMENT DEVICE AND METHOD FOR EVALUATING TURBOMACHINE CLEARANCES

(71) Applicant: General Electric Company, Schenectady, NY (US)

(72) Inventors: John David Memmer, Simpsonville, SC (US); Thomas John Freeman, Canton, GA (US); Robert Flynn, Glasgow (GB); Ariel Harter Lomas, Simpsonville, SC (US); Bradley Steven Carey, Greer, SC (US)

(21) Appl. No.: 14/488,693

(22) Filed: Sep. 17, 2014

Related U.S. Application Data
(60) Provisional application No. 61/878,776, filed on Sep. 17, 2013.

(51) Int. Cl. G01M 15/14; G01B 5/008

(52) U.S. Cl. CPC G01M 15/14; G01B 5/008
USPC 73/112.01; 33/503

(57) ABSTRACT

Measurement devices and methods for evaluating clearances between adjacent components in turbomachines are provided. A measurement device may include a tool and a controller. The tool and controller may determine the clearance by measuring the distance between the adjacent components. The controller may compare the clearance to a predetermined engineering clearance limit and/or a previously measured clearance. A method may include measuring the clearance with a device which includes a controller. The method may further include comparing the clearance in the controller to a predetermined engineering clearance limit and/or a previously measured clearance.

### CROSS REFERENCE TO RELATED APPLICATIONS

The present application claims filing benefit of U.S. Provisional Patent Application Ser. No. 61/878,776 having a filing date of Sep. 17, 2013, which is incorporated by reference herein in its entirety.

### FIELD OF THE INVENTION

The present disclosure relates generally to turbomachines, such as gas turbine systems, and more particularly to methods and apparatus for evaluating clearances in turbomachines.

### BACKGROUND OF THE INVENTION

Turbomachines are widely utilized in fields such as power generation. For example, a conventional gas turbine system includes a compressor section, a combustor section, and at least one turbine section. The compressor section is configured to compress air as the air flows through the compressor section. The air is then flowed from the compressor section to the combustor section, where it is mixed with fuel and combusted, generating a hot gas flow. The hot gas flow is provided to the turbine section, which utilizes the hot gas flow by extracting energy from it to power the compressor, an electrical generator, and other various loads.

Various clearances are required in a turbomachine for the components thereof to properly operate relative to one another. For example, clearances are defined between blade tips and adjacent shroud surfaces in the turbine section of a gas turbine, and clearances are defined between blade tips and compressor casings in the compressor section of a gas turbine. Engineering clearance limits for the various components are predetermined during design of a turbomachine, and typically include ranges of appropriate clearances for relative components which include maximum and minimum clearances. During construction and maintenance of the turbomachine, present clearances may be compared to the required engineering clearance limits to ensure that the various components are positioned within the required specifications for the turbomachine.

Such comparison of present clearances to engineering clearance limits is particularly appropriate during maintenance of a turbomachine. During a typical maintenance period or outage, clearances are measure at the beginning of the outage, when the turbomachine is opened, and at the end of the outage, when the turbomachine is closed. These measurements are then compared to each other and/or to the engineering clearance limits, and modifications are made to bring the present clearances within the required engineering clearance limits.

Currently, however, such clearance measurement operations are tedious and inefficient. For example, current practice is to utilize shim stock or manual gauges to take clearance measurements. These measurements are then each manually compared to the required engineering clearance limits. Such process significantly increases outage times.

Accordingly, improved methods and apparatus for evaluating clearances in turbomachines are desired. In particular, methods and apparatus which facilitate efficient and accurate clearance measurement and analysis would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a measurement device for evaluating a clearance between adjacent components in a turbomachine. The measurement device may include a tool and a controller. The tool and controller may determine the clearance by measuring the distance between the adjacent components. The controller may compare the clearance to a predetermined engineering clearance limit and/or a previously measured clearance.

In another embodiment, the present disclosure is directed to method for evaluating a clearance in a turbomachine. The method may include, for example, measuring the clearance with a device which includes a controller. The method may further include comparing the clearance in the controller to a predetermined engineering clearance limit and/or a previously measured clearance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a gas turbine system according to one embodiment of the present disclosure;

FIG. 2 is a cross-sectional view of a portion of a turbine section according to one embodiment of the present disclosure;

FIG. 3 is a close-up view of a portion of a turbine section, as indicated in FIG. 2, according to one embodiment of the present disclosure;

FIG. 4 is another close-up view of a portion of a turbine section, as indicated in FIG. 2, according to one embodiment of the present disclosure; and

FIG. 5 is a cross-sectional view of a portion of a compressor section according to one embodiment of the present disclosure;

FIG. 6 is a perspective view of a measurement device mounted to a gas turbine system according to one embodiment of the present disclosure; and

FIG. 7 illustrates a measurement device measuring various clearance points in a compressor section according to one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

FIG. 1 is a schematic diagram of a turbomachine, which in the embodiment shown is a gas turbine system 10. It should be understood that the turbomachine of the present disclosure need not be a gas turbine system 10, but rather may be any suitable turbine system or other turbomachine, such as a steam turbine system or other suitable system. The system 10 as shown may include a compressor section 12, a combustor section 14 which may include a plurality of combustors as discussed below, and a turbine section 16. The compressor section 12 and turbine section 16 may be coupled by a shaft 18. The shaft 18 may be a single shaft or a plurality of shaft segments coupled together to form shaft 18. The shaft 18 may further be coupled to a generator or other suitable energy storage device, or may be connected directly to, for example, an electrical grid. An inlet section 19 may provide an air flow to the compressor section 12, and exhaust gases may be exhausted from the turbine section 16 through an exhaust section 20 and exhausted and/or utilized in the system 10 or other suitable system. Exhaust gases from the system 10 may for example be exhausted into the atmosphere, flowed to a steam turbine or other suitable system, or recycled through a heat recovery steam generator.

Referring now to FIG. 2, a side cross-sectional view of a portion of a turbine section 16 of a gas turbine system 10 is illustrated. Turbine section 16 may include various rotary and stationary components which form various turbine stages. In some embodiments, turbine section 16 may have three stages. In other embodiments, a turbine section 16 may have one, two, four or more stages. A single stage of turbine section 16 is generally illustrated in FIG. 2. Such stage may include a plurality of circumferentially spaced nozzles 30 and buckets 32 (one of each of which is shown). The nozzles 30 may be disposed and fixed circumferentially about shaft 18. The buckets 32 may be disposed circumferentially about the shaft 18 and coupled to the shaft 18.

The nozzle 30 may generally include an outer platform 42, an inner platform 44, and a stator vane 46 extending generally radially therebetween. Stator vane 46 may be generally airfoil shaped, having a pressure side and a suction side extending between a leading edge and a trailing edge. An inner stage seal 48 may be coupled to the inner platform 44.

The bucket 32 may include a platform 52, a rotor blade 54 extending radially outward from the platform 32, and a shank 56 extending radially inward from the platform 52. Rotor blade 54 may be generally airfoil shaped, having a pressure side and a suction side extending between a leading edge and a trailing edge. Shank 56 may further include a plurality of angel wings 58 extending therefrom, such as along a generally axial direction.

A dovetail (not shown) extending radially inward from the shank 56 may couple to the bucket 32 to a rotor wheel 60. Additionally, a shroud 62 may be positioned radially outwardly from the bucket 32. Outer platform 42 may be coupled to the shroud 62 to position the nozzle 30 within the turbine section 16.

Referring now to FIG. 5, a side cross-sectional view of a portion of a compressor section 12 of a gas turbine system 10 is illustrated. Turbine section 16 may include various rotary and stationary components which form various compressor stages. In some embodiments, compressor section 12 may have between 10 and 20 stages. In other embodiments, a compressor section 12 may have less than 10 or greater than 20 stages. Four stages of compressor section 12 are generally illustrated in FIG. 5. A stage may include a plurality of circumferentially spaced stationary airfoils 70 and rotating airfoils 72 (one of each of which is shown). The stationary airfoils 70 may be disposed and fixed circumferentially about shaft 18. The rotating airfoils 72 may be disposed circumferentially about the shaft 18 and coupled to the shaft 18.

The stationary airfoils 70 may generally include a stator vane 82 which extends radially inwardly from an outer body 84. The outer body 84 may be coupled to a compressor casing 86 or compressor discharge casing 88 to position the stationary airfoil 70 within the compressor section 12. Compressor casing 86 and compressor discharge casing 88 may additionally be coupled together to form an outer casing of the compressor section 12. (Alternatively, a single outer casing may be utilized).

The rotating airfoils 72 may include a rotor blade 100 extending radially outward from a platform (not shown). A dovetail (not shown) extending radially inward from the platform may couple the rotating airfoils 72 to a rotor wheel 102.

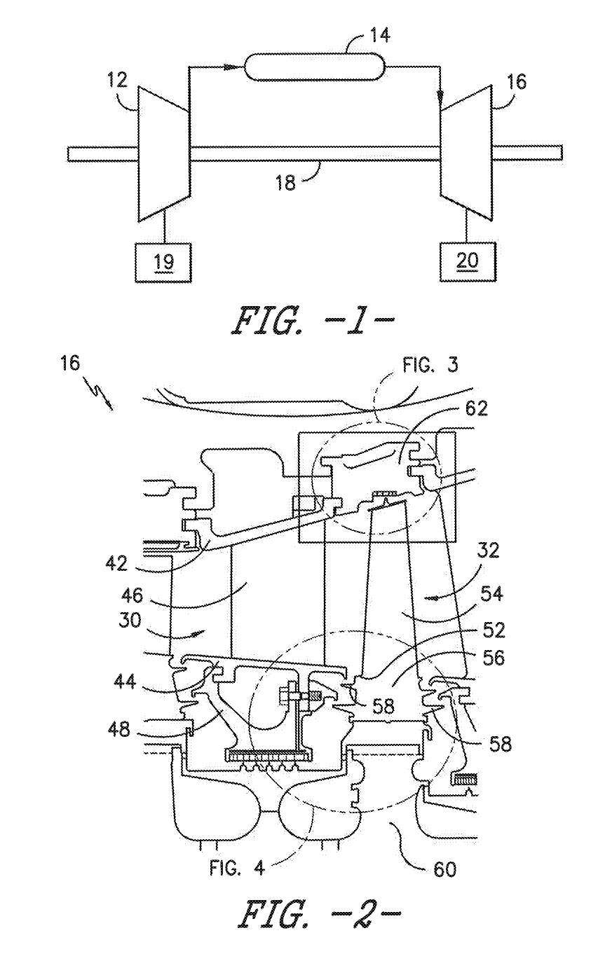

Various clearances may be defined by the various components of a system 10. A clearance is generally a distance between two components. As discussed above, it is desirable to ensure that present clearances between components are within required engineering clearance limits, such as within the ranges and tolerances defined by the predetermined engineering clearance limits. Referring now to FIGS. 3-5, various clearances are illustrated. In the embodiments shown, radial clearances 90 and axial clearances 92 are illustrated. However, any suitable clearances in any suitable direction between any suitable components are within the scope and spirit of the present disclosure.

For example, FIG. 3 illustrates various clearances between a rotor blade 54 and a shroud 62. As shown, a radial clearance 90 may be defined between a tip 112 of the blade 54, such as the rail 114 thereof, and an abradable material block 116 of the shroud 62. An axial clearance 92 may be defined between the rail 114 and an axially adjacent surface 118 of the shroud 62. An axial clearance 92 may additionally be defined between axially adjacent surfaces 120, 122 of the tip 102 and shroud 62, respectively.

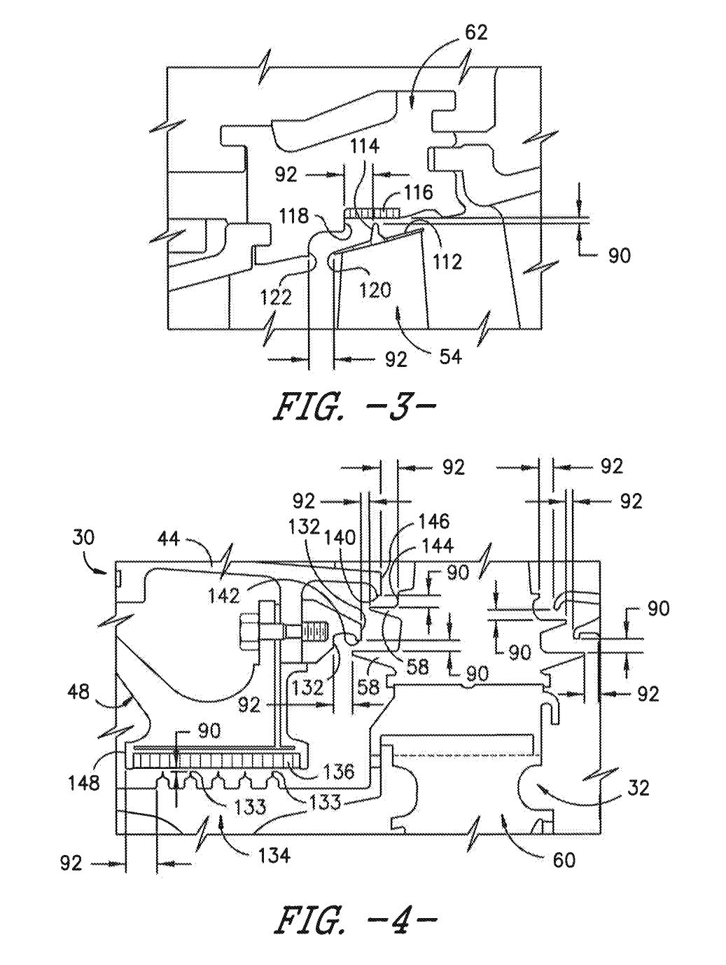

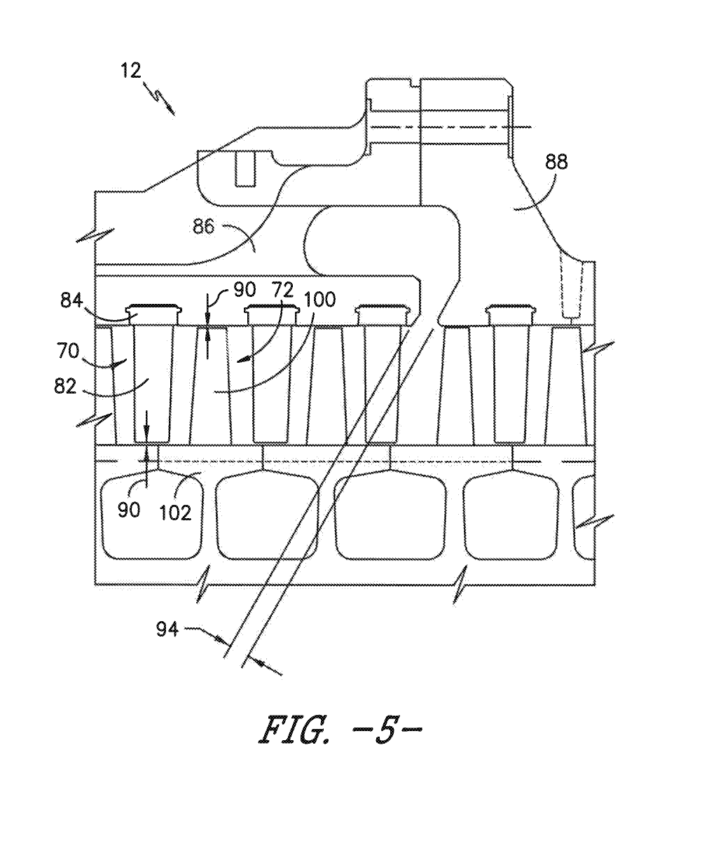

FIG. 4 illustrates various clearances between a bucket 32 and a nozzle 30 and inner stage seal 48. As shown, a radial clearance 90 may be defined between each angel wing 58 and a radially adjacent surface, such as a radially adjacent inner stage seal surface 132. A radial clearance 90 may additionally be defined between a seal tooth 133 of a spacer wheel 134 that is between axially adjacent rotor wheels 60 and an abradable material block 136 of the inner stage seal 48. An axial clearance 92 may be defined between each angel wing 58 and an axially adjacent surface, such as an axially adjacent inner platform surface 140 or an axially adjacent inner stage seal surface 142. An axial clearance 92 may additionally be defined between a platform leading edge 144 and an axially adjacent inner platform surface 146. An axial clearance 92 may additionally be defined between a seal tooth 133 and an end 148 of the inner stage seal 48.

FIG. 5 illustrates various clearances between various components in a compressor section 12. As shown, a radial clearance may be defined between a blade 100 and casing 86, and between a vane 82 and rotor wheel 102. Further, a clearance 94 may be defined for an airslot between the compressor casing 86 and compressor discharge casing 88. Such clearance 94 may be defined at an angle to the radial and axial clearance directions.

It should be understood that the present disclosure is not limited to the above-disclosed clearances. Rather, any suitable clearance in any section of a gas turbine system 10 or other turbomachine is within the scope and spirit of the present disclosure.

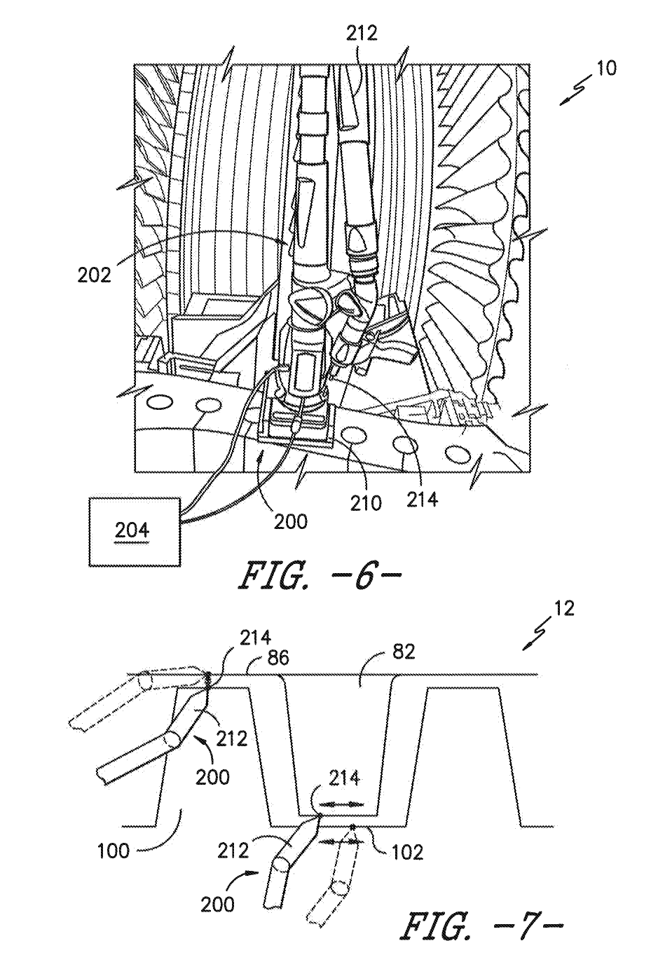

As discussed above, accurate and efficient apparatus for measuring such clearances 90, 92, 94 are desired. Accordingly, and referring to FIGS. 6 and 7, the present disclosure is further directed to measurement devices 200 for measuring such clearances 90, 92, 94.

As illustrated, a measuring device 200 may include a tool 202. The tool 202 may operate to measure relative locations of various system 10 components, to calculate present clearances 90, 92, 94, or measure the clearances 90, 92, 94 themselves. In some embodiments, for example, a tool 202 may be a coordinate measuring machine, as illustrated. Tool 202 in these embodiments may include a base 210 and an articulated arm 212. The base 210 may be connectable to a suitable location in the system 10, such as to a casing thereof. In exemplary embodiments, base 210 may be magnetic, and may thus be magnetically connectable to a component of the system 10 as shown. The articulated arm 212 may include various portions and hinges which provide the arm 212 with, for example, six degrees of freedom, such that a wide variety of movements of the arm 212 are available. A probe tip 214 may be provided on an end of the arm 212. The tool 202 in these embodiments may operate to measure relative locations of various system 10 components. For example, referring to FIG. 7, tool 202 is illustrated measuring relative locations for two radial clearances 90. The tip 214 may be initially brought into contact with a first surface that defines a clearance, such as a rotor blade 100 or stator vane 82 as shown. A location measurement may be taken with the tip 214 in such contact. The tip 214 may then be brought into contact with a second surface that defines a clearance, such as a compressor casing 86 or rotor wheel 102 as shown. A location measurement may be taken with the tip 214 in such contact. The tool 202 may be capable of defining these measurements relative to each other in 3-dimensional space, such that a clearance 90, 92, 94 can be determined based on the relative locations.

As further shown with respect to the clearance 90 defined by the stator vane 82 and rotor wheel 102, in some embodiments, the tip 214 may take contact measurements along a 2-dimensional distance (as shown) or within a 3-dimensional plane for each component. The tool 202 may be capable of defining these 2-dimensional or 3-dimensional measurements relative to each other in 3-dimensional space, such that clearances 90, 92, 94 can be determined based on the relative locations.

Suitable coordinate measuring machines are commercially available from, for example, ARGON 3D MEASUREMENT SERVICES, with a place of business in Belgium, and FARO TECHNOLOGIES, with a place of business in Florida, USA.

In other embodiments, a tool 202 may measure the clearances 90, 92, 94. For example, a suitable laser device may direct a laser between two components that define a clearance, such that the length of the laser may be the clearance 90, 92, 94. A suitable photo- or video-graphic device may be utilized to record clearances 90, 92, 94 for analysis.

A device 200 according to the present disclosure may further include a controller 204, which may be in communication with the tool 202. Controller 104 may provide a variety of functions, including calculating clearances 90, 92, 94 based on data, such as location data, from the tool 202, and comparing clearance measurements to, for example, predetermined engineering clearance limits and other clearance measurements.

It should be appreciated that the controller 204 may generally comprise a computer or any other suitable processing unit. Thus, in several embodiments, the controller 204 may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the controller 204 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the controller 204 to perform various computer-implemented functions. In addition, the controller 204 may also include various input/output channels for receiving inputs from and sending control signals to sensors and/or other measurement devices, such as the tool 202.

It should be understood that tool 202 and controller 204 may be separate components or themselves components of a single device. Further, a single controller 204 or multiple controllers 204 may be utilized. For example, tool 202 may include an integrated controller 204, and may further be connected to an additionally controller 204.

Device 200 may thus determine present clearances 90, 92, 94 as required. In exemplary embodiments, the device 200 may further be utilized to analyze such clearances 90, 92, 94. For example, the device 200, such as the controller 204 thereof, may compare present clearances 90, 92, 94 to predetermined engineering clearance limits, or to previously measured clearances. Such predetermined engineering clearance limits and/or previously measured clearances may be programmed into and/or stored in the controller 204. As discussed, present clearance measurements may be taken in some embodiments at the beginning of an outage and at the end of an outage. Thus, for example, present clearance measurements taken at the end of an outage may be compared to present clearance measurements taken at the beginning of an outage and to predetermined engineering clearance limits. Thus, adjustments can be made to various system 10 components if necessary to ensure that all clearances are correct and all components are correctly positioned before the system 10 is operated.

Additionally, in exemplary embodiments, the device 200 can be utilized for documentation of clearances 90, 92, 94. For example, clearances 90, 92, 94 and engineering clearance limits stored in the device 200, such as in the controller 204 thereof, can be output into summary reports or other suitable documentation, to document the clearances. Such documentation may be prepared, for example, when clearances are evaluated at the beginning and at the end of an outage.

The present disclosure is further directed to methods for evaluating clearances between components in turbomachines. A method may include, for example, determining a clearance utilizing, for example, a device comprising a controller. The method may further include utilizing the controller to compare the clearance to another clearance, such as a predetermined engineering clearance limit or a previously determined clearance. The method may further include, for example, displaying the clearance. Such comparison and display may be performed in exemplary embodiments in real time. For example, after determining a clearance, the controller may compare the clearance and display an indication on, for example, a screen thereof, relative to the clearance. The indication may indicate whether, for example, the measure clearance is within a predetermined engineering clearance limit and/or is approximately equal to (with a suitable tolerance) a previously determined clearance. Further, the method may include, for example, documenting the clearance, as discussed above.

Advantageously, use of a device 200 according to the present disclosure may facilitate efficient and accurate clearance measurements and analysis. For example, the present inventors have estimated that use of such device 200 according to the present disclosure may save between one and two days of outage time. Further, such devices 200 provide more accurate clearance measurements and analysis relative to previously known measurement methods and apparatus.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A measurement device for evaluating a clearance between adjacent components in a turbomachine, the measurement device comprising:
a tool operable to measure locations of the components within the turbomachine; and
a controller, the controller configured for:
determining a present clearance based on the locations of the components; and
comparing the present clearance to a stored clearance value.

2. The measurement device of claim 1, wherein the tool is a coordinate measuring machine.

3. The measurement device of claim 1, wherein the tool comprises a base, an articulated arm, and a probe tip.

4. The measurement device of claim 3, wherein the tool is capable of six degree of freedom movement.

5. The measurement device of claim 3, wherein the base is magnetic.

6. The measurement device of claim 1, wherein the stored clearance value is one of a predetermined engineering clearance limit or a previously measured clearance.

7. The measurement device of claim 6, wherein the stored clearance value is a predetermined engineering clearance limit.

8. The measurement device of claim 6, wherein the stored clearance value is a previously measured clearance.

9. The measurement device of claim 1, wherein the determining step comprises:
measuring a first location of a probe tip of the tool when the probe tip contacts a first surface that defines the present clearance;
measuring a second location of the probe tip of the tool when the probe tip contacts a second surface that defines the present clearance; and
calculating the present clearance based on the first location and the second location.

10. The measurement device of claim 1, wherein the controller is further configured for outputting the present clearance.

11. A method for evaluating a clearance between adjacent components in a turbomachine, the method comprising:
determining, with a controller comprising a processor, a present clearance based on the locations of the components; and
comparing, with the controller, the present clearance to a stored clearance value.

12. The method of claim 11, wherein the stored clearance value is one of a predetermined engineering clearance limit or a previously measured clearance.

13. The method of claim 12, wherein the stored clearance value is a predetermined engineering clearance limit.

14. The method of claim 12, wherein the stored clearance value is a previously measured clearance.

15. The method of claim 11, wherein the determining step comprises:
measuring a first location of a probe tip of a tool in communication with the controller when the probe tip contacts a first surface that defines the present clearance;
measuring a second location of the probe tip when the probe tip contacts a second surface that defines the present clearance; and
calculating the present clearance based on the first location and the second location.

16. The method of claim 11, wherein the controller is further configured for outputting the present clearance.
